(19) United States
(12) Patent Application Publication
(10) Pub. No.: US 2026/0364553 A1
(43) Pub. Date: Nov. 19, 2026

(54) HETEROGENEOUS SUBSTANCE MIXING KIT

(71) Applicant: BODITECH MED INC., Gangwon-do (KR)

(72) Inventors: Byeong Chul KIM, Gangwon-do (KR); Sang Hyun PARK, Gangwon-do (KR)

(21) Appl. No.: 19/126,584

(22) PCT Filed: Oct. 2, 2024
(86) PCT No.: PCT/KR2024/014955

§ 371 Date: May 1, 2025

(30) Foreign Application Priority Data
Oct. 6, 2023 (KR) 10-2023-0133503

(51) Int. Cl. B01F 35/71; B01F 33/501; B01L 3/00

(52) U.S. Cl. CPC B01F 35/7161; B01F 33/50111; B01F 35/7137; B01F 35/7162; B01L 3/502; B01L 2200/026; B01L 2200/0689; B01L 2200/16; B01L 2300/0672

(57) ABSTRACT

The present disclosure relates to a heterogeneous substance mixing kit including a first container member having a first filling space in which a first substance is filled, a first blocker sealing an inlet of the first filling space, and a piercing member protruding a predetermined length from an inner bottom of the first filling space in an axial direction; and a second container member having a second filling space in which a second substance is filled and configured to be, at the time of use, inserted into the first container member through the inlet of the first container member. And the second container member includes a second blocker that blocks one end of the second filling space and is able to be opened by the piercing member during coupling of the first and second container members and a third blocker that blocks the other end of the second filling space and is able to be opened as necessary.

### TECHNICAL FIELD

The present application claims the benefit of Korean Patent Application No. 10-2023-0133503 filed to the Korean Intellectual Property Office on Oct. 6, 2023, the entire contents of which are incorporated herein by reference in its entirety. The present application relates to a heterogeneous substance mixing kit that can safely and separately store multiple different substances that are mixed and used and allows the multiple separately stored substances to be easily mixed and used at the time of use.

### BACKGROUND ART

As is well known, various chemical or biochemical tests are used to measure biological indicators related to specific diseases, general health conditions, or infections. These chemical or biochemical tests are usually performed through multi-step chemical reactions and physical manipulations using various reagents and instruments.

For example, when detecting biochemical substances such as occult blood, specific chemicals, or proteins contained in feces or mucus, there is a need for multiple steps of physical manipulation, such as collecting a sample, placing the collected sample in a specific container, reacting the collected sample with one or more reagents, and then distributing the reacted sample from the container before application to a testing/reading device.

When a sample to be analyzed, for example, blood, a detection antibody labeled with a fluorescent substance, etc., and whole blood are used, the sample is mixed in a quantitative ratio and reacted with a solution (reagent) containing a red blood cell lysing reagent, and sample is loaded onto a sample pad of an analysis device or cartridge to perform analysis.

As such, solutions used in chemical or biochemical tests are often composed of a mixture of several different substances. However, if multiple different substances used for disease diagnosis are mixed in advance, they can easily deteriorate due to evaporation or moisture, which makes it difficult to accurately diagnose or analyze them, so they must be stored in separate containers. In addition, at the time of testing, separately stored each substances are measured individually with a pipette or other instruments and mixed, or each substances to be mixed is stored individually in containers and poured into a single container according to predetermined mixing ratio to mix, then dispensed with a pipette.

Therefore, not only is it difficult to store various substances to be used as reagents or the like, but there is also a problem that a task of diagnosis or analysis is quite complicated.

Meanwhile, Prior Art Document 1 discloses a dropper that has a tip part inducing a capillary phenomenon at a lower end of a lower part of an inlet tube in which a bromine latex ball is embedded, thereby allowing blood, the bromine latex ball, and a buffer solution to be mixed and dispensed with a single dropper.

However, Prior Art Document 1 has problems that, because a distal end of the tip part is open due to the nature of the dropper, the dropper should be managed in separate packaging and cannot be used when both substances to be mixed are liquids.

### DISCLOSURE

### Technical Problem

The present disclosure has been made to solve the above-mentioned problems occurring in the prior arts, and it is an aspect of the present disclosure to provide a dissimilar substance mixing kit that can safely and separately store multiple different substances to be used as, for example, reagents for diagnosis or analysis and allows the separately stored dissimilar substances to be easily mixed and used at the time of use.

Embodiments of the present disclosure are not limited to the above-mentioned embodiment, and other unmentioned embodiments will be apparent to a person skilled in the art from the following description.

### Technical Solution

According to an aspect of the present disclosure, there is provided a heterogeneous substance mixing kit including a first container member having a first filling space in which a first substance is filled and including a first blocker sealing an inlet of the first filling space and a piercing member protruding a predetermined length from an inner bottom of the first filling space in an axial direction; and a second container member having a second filling space in which a second substance is filled and configured to be, at the time of use, inserted into the first container member through the inlet of the first container member. And the second container member including a second blocker that blocks one end of the second filling space and is able to be opened by the piercing member during coupling of the first and second container members and a third blocker that blocks the other end of the second filling space and is able to be opened when necessary.

According to one embodiment of the present disclosure, the second blocker may be formed of a perforated blocking member that is integrally configured with the second container member and has a ring-shaped perforated line formed on an edge to correspond to an inner peripheral surface of the second filling space to allow the perforated blocking member to be torn off from the second container member by the piercing member during the coupling of the first and second container members.

According to one embodiment of the present disclosure, the perforated blocking member may have an edge portion configured to be inclined and may have a shape that is concave toward an inner side of the second filling space.

According to one embodiment of the present disclosure, the second blocker may be configured as a second sealing membrane that is press-fitted to one end of the second container member and through which the piercing member is able to pass during the coupling of the first and second container members.

According to one embodiment of the present disclosure, the piercing member may have a +-shaped, Y-shaped, or T-shaped cross-section.

According to one embodiment of the present disclosure, the third blocker may be a third sealing membrane formed as a sticker that is press-fitted or attached to an upper end of the second container member and removable or may be a stopper that is coupled to the upper end of the second container member in an openable-closeable manner.

### Advantageous Effects

According to a heterogeneous substance mixing kit of the present disclosure, since first and second substances to be mixed with each other can be separately stored in first and second container members that are coupled to each other at the time of use, multiple different substances to be mixed and used in a chemical or biochemical test or the like can be safely stored separately.

In addition, during a test or analysis, the multiple substances stored separately can be easily mixed with a simple operation of coupling the second container member to the first container member, and a mixture of substances can easily be withdrawn and dispensed using a pipette or the like after opening a stopper provided at the second container member.

Thus, there is no need to use separate containers or tools for storage and mixing of multiple substances to be mixed and used at the time of diagnosis or analysis.

Furthermore, since multiple substances to be mixed can be stored separately in a sealed state in the first and second container members, there are advantages that multiple substances can be safely stored and mixed even when the substances are both liquids as well as when one substance is a liquid and the other substance is a solid, and heterogeneous substances can be stored and mixed regardless of a sampling volume.

### BRIEF DESCRIPTION OF DRAWINGS

FIG. 1 is an exploded perspective view of a heterogeneous substance mixing kit according to the present disclosure,

FIG. 2 is an exploded cross-sectional view of the heterogeneous substance mixing kit according to the present disclosure.

FIG. 3 is a bottom view of a second container member of the heterogeneous substance mixing kit according to the present disclosure.

FIG. 4 is cross-sectional views showing coupled states of the heterogeneous substance mixing kit according to the present disclosure.

FIG. 5 is a perspective view showing a method of using the heterogeneous substance mixing kit according to the present disclosure.

FIG. 6 is a partially cut side view illustrating another embodiment of a third blocker of the heterogeneous substance mixing kit according to the present disclosure.

FIG. 7 is an exploded perspective view illustrating another embodiment of a second blocker of the heterogeneous substance mixing kit according to the present disclosure.

FIG. 8 is a cross-sectional view of a coupled state of the heterogeneous substance mixing kit of the present disclosure that shows a state in which the other embodiment of the second blocker illustrated in FIG. 7 is applied.

FIG. 9 is a cross-sectional view along line IX-IX of FIG. 8.

### BEST MODES OF THE DISCLOSURE

Specific features and other advantages of the present disclosure, and methods of achieving the same should become clear from embodiments described in detail below with reference to the accompanying drawings. However, the present disclosure is not limited to the embodiments disclosed herein and may be embodied in many different forms. The present embodiments are only provided to make the disclosure of the present disclosure complete and fully inform a person skilled in the art to which the present disclosure belongs. The scope of the present disclosure is only defined by the scope of the claims. The same reference numerals refer to the same components throughout the specification.

In embodiments of the present disclosure, a first substance and/or a second substance may be a liquid or solid reaction reagent, specifically, but not limited to, silica particles, proteins, amino acids, nucleic acids, lipids, carbohydrates, metabolites, reagents used as supports, antibodies that selectively separate proteins, detection agents, blocking agents, light signal enhancers, light signal quenchers, or other reagents.

Hereinafter, a heterogeneous substance mixing kit according to embodiments of the present disclosure will be described with reference to the drawings.

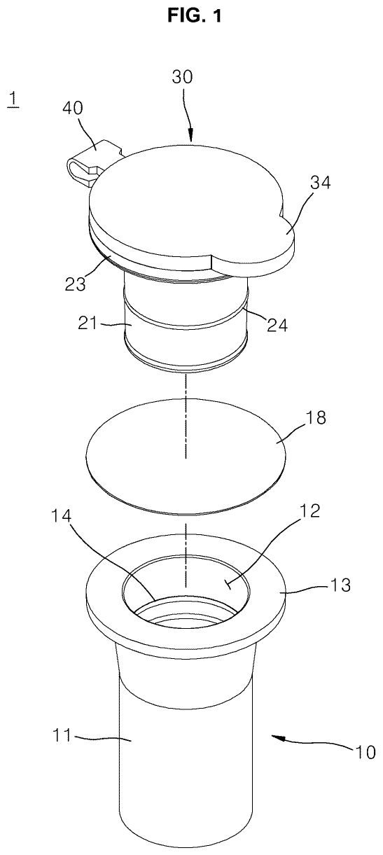

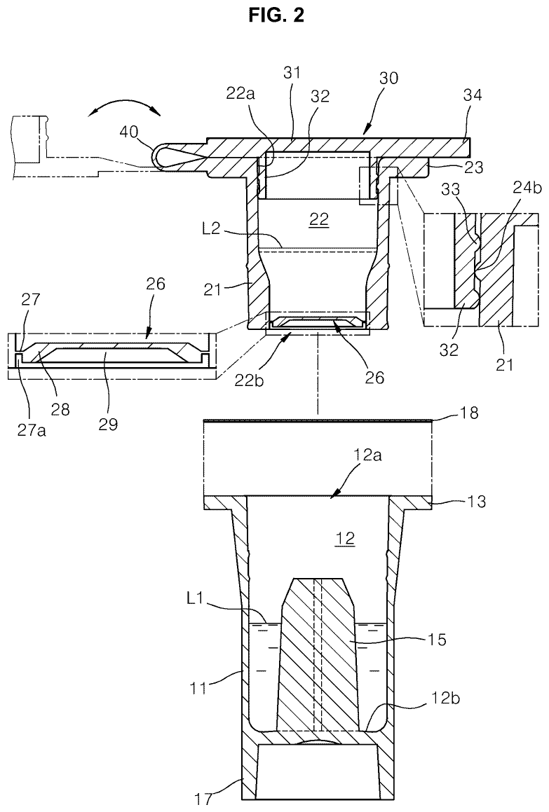

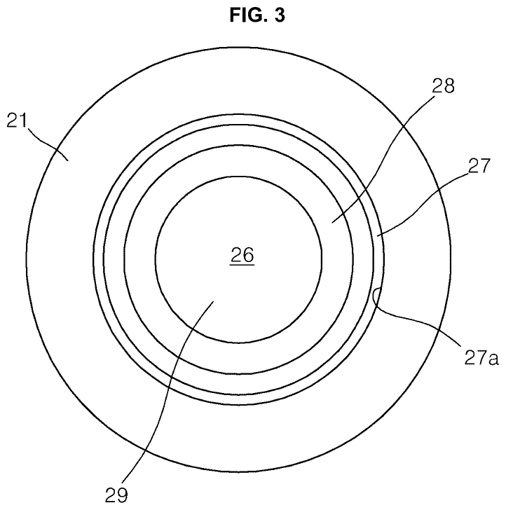

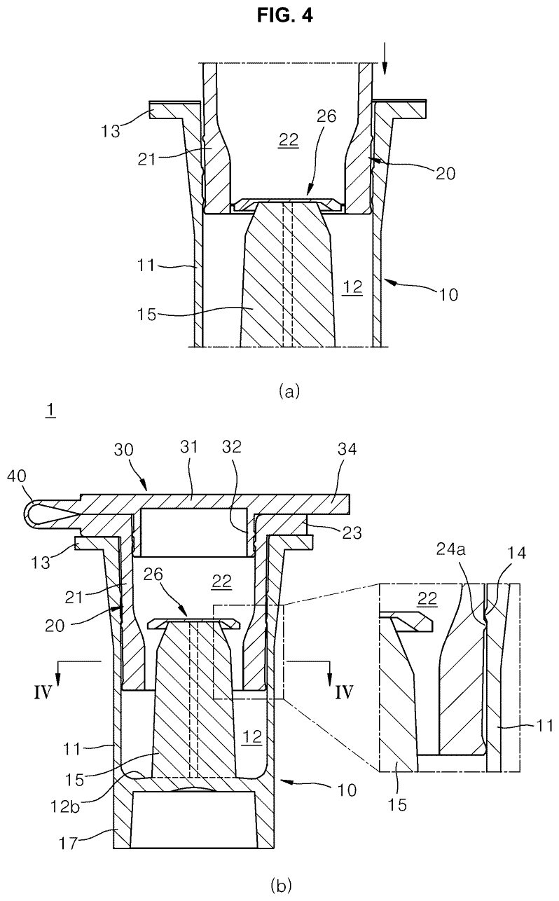

In FIGS. 1 to 4, a heterogeneous substance mixing kit 1 according to the present disclosure may be configured to basically include a first container member 10 and a second container member 20 inserted into the first container member 10.

The first container member 10 may be filled with and store a first substance L1 in a sealed state. The first container member 10 may include a body 11 in the form of tube having a first filling space 12 inside and a piercing member 15 that is able to open a second blocker of the second container member 20, which will be described below, during coupling of the first container member 10 to the second container member 20.

The body 11 may have a long, cylindrical tubular shape to make it easy to hold and dispense, and one end (upper end) of the body 11 may be open to function as an inlet 12a of the first filling space 12. The inlet 12a of the body 11 is closed by a first blocker after the body 11 is filled with the first substance L1 to securely seal the first substance L1 filled in the body 11.

The first blocker may be implemented in various forms. For example, the first blocker may be configured as a typical stopper (not illustrated) or may be configured as a first sealing membrane 18 that is press-fitted to one end of the body 11 as illustrated. Accordingly, a flange 13 may be formed outward at an inlet 12a side end of the body 11 for stable attachment of the first sealing membrane 18.

Here, the first sealing membrane 18 may either be configured to be torn by the second container member 20 during coupling of the first container member 10 and the second container member 20, or configured as a sticker that can be peeled off from the first container member 10 in advance before the coupling of the first container member 10 and the second container member 20. The first substance L1 may be a liquid or a solid such as granules, and a case in which the first substance L1 in the present embodiment is described as a liquid.

First leakage preventing protrusions 14 and 24a having ring shapes may be provided on at least one of an upper side of an inner circumference of the body 11 of the first container member 10 and an outer circumference of the second container member 20. Preferably, to more reliably ensure watertightness, the first leakage preventing protrusions 14 and 24a may be provided on both the inner circumference of the first container member 10 and the outer circumference of the second container member 20, and two or more first leakage preventing protrusions 14 and 24a may be disposed at predetermined intervals in an axial direction. The first leakage preventing protrusions 14 and 24a may prevent leakage of a mixture when the first substance L1 is mixed with a second substance L2 in the first filling space 12 by shaking after the first and second container members 10 and 20 are coupled as will be described below. Meanwhile, an O-ring may be provided on the outer circumference of the second container member 20 instead of the first leakage preventing protrusions 14 and 24a.

The piercing member 15 may be integrally formed with the body 11. The piercing member 15 may be formed to protrude a predetermined length from an inner bottom 12b of the first filling space 12 in the axial direction. Specifically, the piercing member 15 is formed with a length that allows a distal end of the piercing member 15 to sufficiently intrude into the second blocker of the second container member 20, which will be described below, and enter a second filling space 22 when the first container member 10 and the second container member 20 are completely coupled.

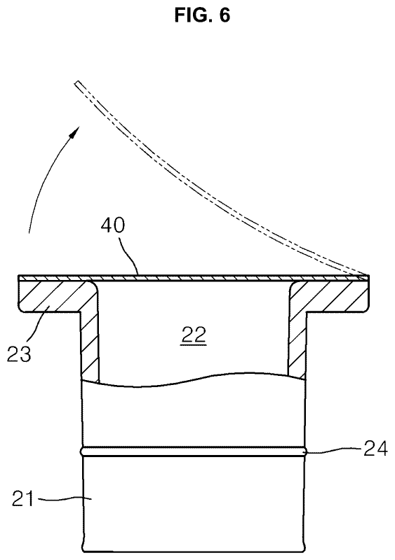

The piercing member 15 may be configured in various forms but is preferably formed with a structure that opens the second blocker and then allows the second substance L2 filled in the second filling space 22 of the second container member 20 to enter easily the first filling space 12 of the first container member 10. In particular, as illustrated in FIGS. 6 to 8, when the second blocker of the second container member 20, which will be described below, is configured as a perforable second sealing membrane 25, the piercing member 15 may have a configuration that makes it easy to tear the second sealing membrane 25 using a coupling force of the first and second container members 10 and 20 during coupling of the first and second container members 10 and 20. To this end, for example, the piercing member 15 may be configured to have a +-shaped cross-section with four ribs 16 formed radically, and since the +-shaped cross-section is more advantageous for forming a gap between the second sealing membrane 25 and the piercing member 15 after piercing as well as for tearing the second sealing membrane 25 as compared to a straight line-shaped or circular cross-section.

Meanwhile, although not separately illustrated, the piercing member 15 may be configured to have a Y-shaped or T-shaped cross-section. Like the +-shaped cross-section described above, the Y-shaped or T-shaped cross-section may also be advantageous for tearing the second sealing membrane 25 and forming a gap between the second sealing membrane 25 and the piercing member 15 after piercing.

On the other hand, a base portion 17 may be provided at the other end (lower end) of the first container member 10 for the first container member 10 to safely stand upright while coupled to the second container member 20 at the time of dispensing using a pipette P or the like.

The second container member 20 has the second filling space 22 to be filled with and store the second substance L2, which will be mixed with the first substance L1, in a sealed state. The second filling space 22 may be formed by penetrating a body 21, which is formed in a cylindrical shape, in the axial direction. A lower end opening 22b (a side fitted into the first container member) of the second filling space 22 may be sealed by the second blocker that can be opened by the piercing member 15 during the coupling of the first and second container members 10 and 20. In addition, an upper end opening 22a of the second filling space 22 may be sealed by a third blocker that can be opened when needed (during use). A flange 23 may be provided on an outer circumference of an upper end of the body 21 to stably come into contact with the third blocker. and support it. In addition, the second substance L2 may also be a liquid or a solid such as granules, and a case in which the second substance L2 is a liquid like the first substance L1 will be described as an example in the present embodiment.

For example, the second blocker may be formed of a perforated blocking member 26 that is integrally configured with the second container member 20 and may be torn off from the second container member 20 by the piercing member 15 during the coupling of the first and second container members 10 and 20.

The perforated blocking member 26 may be configured as a disc that is integrally formed with an inner surface of the lower end opening 22b of the second filling space 22 and may have a perforated line 27, which is formed in a ring shape, formed on an edge to correspond to an inner circumferential surface of the second filling space 22. The perforated line 27 may have a very small thickness compared to a thickness of the perforated blocking member 26 due to a tear-off guide groove 27a formed inward on a surface of the perforated blocking member 26, and in this way, the perforated line 27 can easily be torn due to a force applied to the perforated blocking member 26 by the piercing member 15 during the coupling of the first and second container members 10 and 20. Preferably, the tear-off guide groove 27a may be formed on a side coming in contact with the piercing member 15.

The perforated blocking member 26 may be configured in a flat plate shape but may have a shape that is concave toward an inner side of the second filling space 22 to be more easily torn off during the coupling of the first and second container members 10 and 20. To this end, the perforated blocking member 26 may be configured with an inclined portion 28 that has an edge portion appropriately inclined toward the second filling space 22 and may have a concave portion 29 formed on a lower surface to allow the distal end of the piercing member 15 to be seated thereon.

For example, the third blocker may be configured as a stopper 30 that can open/close the upper end opening 22a of the second container member 20. The stopper 30 may be a component including a blocking portion 31 formed in a disc shape and coming into contact with the flange 23 of the second container member 20 and a fitting portion 32 formed in a cylindrical shape, formed to protrude from a lower surface of the blocking portion 31, and fitted into the second filling space 22 through the upper end opening 22a of the second container member 20. Second leakage preventing protrusions 33 and 24b may be provided on at least one of an outer circumferences of the fitting portion 32 of the stopper 30 and an inner circumference of an upper side of the second filling space 22 of the second container member 20. The second leakage preventing protrusions 33 and 24b may prevent the second substance L2 filled in the second filling space 22 from leaking out during storage and may be provided on both the outer circumference of the fitting portion 32 and the inner circumference of the second filling space 22 to more reliably prevent leakage.

Furthermore, an opening/closing guide tab 34 may be provided on one side of the blocking portion 31 of the stopper 30 to easily open/close the stopper 30. The stopper 30 may be a separate component from the second container member 20 or may be a component integrally connected thereto by a connection tab 40 as illustrated.

Meanwhile, as illustrated in FIG. 6, the third blocker may be configured as a third sealing membrane 50 formed as a sticker that is press-fitted or attached to an upper end of the second container member 20 and removable from the second container member 20 during use, that is, after the first and second container members 10 and 20 are coupled to each other.

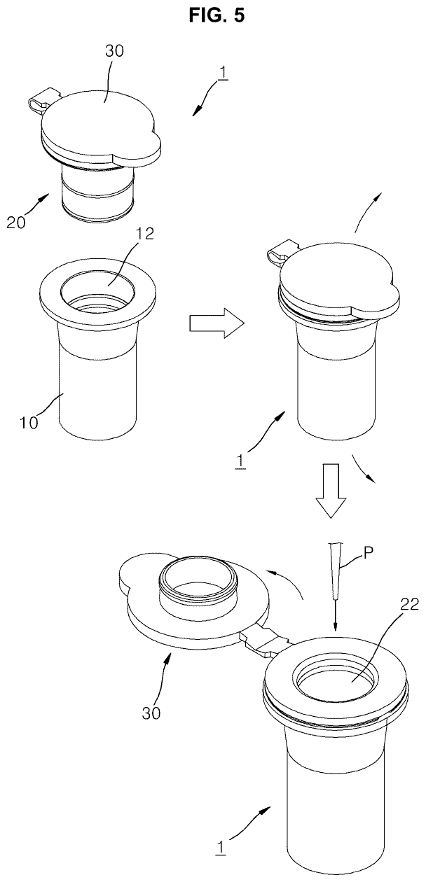

A method of using the heterogeneous substance mixing kit 1 of the present disclosure will be described with reference to FIG. 5.

First, after the first sealing membrane 18 sealing the inlet 12a of the first container member 10 is peeled off and removed or the second container material 20 with the first sealing membrane 18 still attached is inserted into the open inlet 12a of the first container member 10. Then, the second container member 20 may be inserted into the first filling space 12 of the first container member 10, and the first and second container members 10 and 20 may be integrally coupled to each other. At this point, when the second container member 20 is fitted while the first sealing membrane 18 is attached, the first and second container members 10 and 20 may be integrally coupled to each other as the first sealing membrane 18 is torn by the second container member 20.

Simultaneously, the distal end of the piercing member 15 comes into contact with and presses a lower surface of the perforated blocking member 26 of the second container member 20, and accordingly, the lower end opening 22b of the second container member 20 may be opened as the perforated line 27 formed on the edge of the perforated blocking member 26 cut off from the second container member 20. Then, the first and second filling spaces 12 and 22 connect to each other, so that the second substance L2 filled in the second filling space 22 of the second container member 20 is able to easily enter the first filling space 12 of the first container member 10 through the open lower end opening 22b of the second container member 20.

In this state, when the heterogeneous substance mixing kit 1 of the present disclosure in which the first and second container members 10 and 20 are coupled to each other is suitably shaken, the first substance L1 and the second substance L2 may be reliably mixed in the first filling space 12 of the first container member 10.

Next, the third blocker of the second container member 20 coupled to the first container member 10 is opened. At this time, when the third blocker is configured as the stopper 30, the stopper 30 is opened, or when the third blocker is configured as the third sealing membrane, the third sealing membrane is peeled off and removed from the second container member 20. Then, the first filling space 12 may be opened as the upper end opening 22a of the second filling space 22 of the second container member 20 is opened. In this state, it is possible to withdraw and dispense the mixture by inserting a tool such as the pipette P into the first filling space 12 through the second filling space 22 of the second container member 20 that is open.

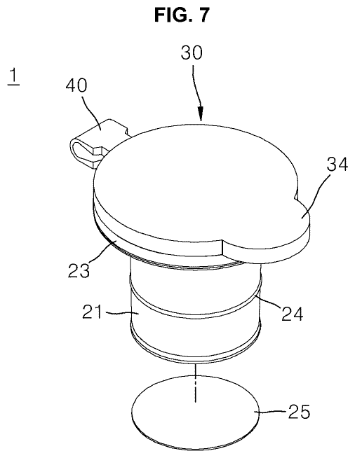

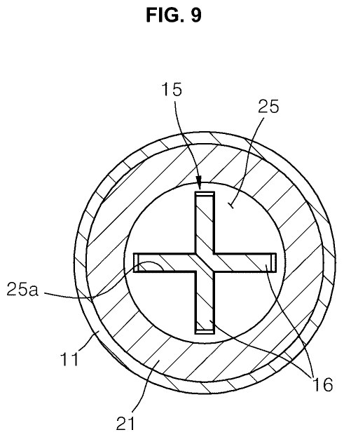

FIGS. 7 to 9 illustrate another embodiment of the second blocker of the heterogeneous substance mixing kit 1 according to the present disclosure.

This embodiment has a configuration in which, in the configuration of the above-described embodiment, the second blocker is configured as the second sealing membrane 25 that is press-fitted to a lower end of the second container member 20 and through which the piercing member 15 is able to pass during the coupling of the first and second container members 10 and 20.

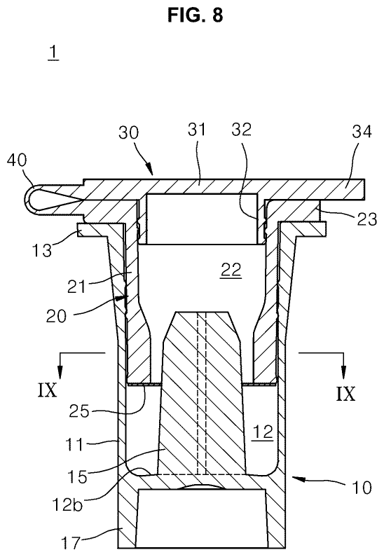

In the embodiment having such a configuration, as illustrated in FIG. 8, the second sealing membrane 25 may be torn and pierced by the piercing member 15 during the coupling of the first and second container members 10 and 20, and accordingly, the second filling space 22 may communicate with the first filling space 12 through an inflow hole 25a formed in the second sealing membrane 25, and the second substance L2 may enter the first filling space 12.

A person skilled in the art to which the present invention pertains should understand that the present disclosure may be carried out in other specific forms without changing the technical spirit or essential features thereof. Therefore, the embodiments described above should be understood in all aspects as exemplary and not limiting. The scope of the present disclosure is shown by the claims below rather than by the detailed description provided above, and all changes or modifications derived from the meaning and scope of the claims and their equivalent concepts should be construed as being included in the scope of the present disclosure.

1. A heterogeneous substance mixing kit comprising:
a first container member having a first filling space in which a first substance is filled and including a first blocker sealing an inlet of the first filling space and a piercing member protruding a predetermined length from an inner bottom of the first filling space in an axial direction; and
a second container member having a second filling space in which a second substance is filled and configured to be, at the time of use, inserted into the first container member through the inlet of the first container member,
wherein the second container member includes
a second blocker that blocks one end of the second filling space and is able to be opened by the piercing member during coupling of the first and second container members and
a third blocker that blocks the other end of the second filling space and is able to be opened when necessary.

2. The heterogeneous substance mixing kit of claim 1, wherein the second blocker is formed of a perforated blocking member that is integrally configured with the second container member and has a ring-shaped perforated line formed on an edge to correspond to an inner peripheral surface of the second filling space to allow the perforated blocking member to be torn off from the second container member by the piercing member during the coupling of the first and second container members.

3. The heterogeneous substance mixing kit of claim 2, wherein the perforated blocking member has an edge portion configured to be inclined and has a shape that is concave toward an inner side of the second filling space.

4. The heterogeneous substance mixing kit of claim 1, wherein the second blocker is configured as a second sealing membrane that is press-fitted to one end of the second container member and through which the piercing member is able to pass during the coupling of the first and second container members.

5. The heterogeneous substance mixing kit of claim 2, wherein the piercing member has a +-shaped, Y-shaped, or T-shaped cross-section.

6. The heterogeneous substance mixing kit of claim 1, wherein the third blocker is a third sealing membrane formed as a sticker that is press-fitted or attached to an upper end of the second container member and removable or a stopper that is coupled to the upper end of the second container member in an openable-closeable manner.
